(19) United States
(12) Patent Application Publication
(10) Pub. No.: US 2023/0347859 A1
(43) Pub. Date: Nov. 2, 2023

(54) BRAKE CONTROL SYSTEM

(71) Applicant: Transportation IP Holdings, LLC, Norwalk, CT (US)

(72) Inventors: Andrew Staats, Cedar Rapids, IA (US); Stuart Barr, Cedar Rapids, IA (US)

(21) Appl. No.: 18/127,930

(22) Filed: Mar. 29, 2023

Related U.S. Application Data
(60) Provisional application No. 63/335,776, filed on Apr. 28, 2022.

(51) Int. Cl. B60T 17/22

(52) U.S. Cl. CPC B60T 17/22; B60T 2210/30; B60T 2210/24

(57) ABSTRACT

The present disclosure relates generally to systems and methods for determining a weather condition for an upcoming area through which a vehicle system will travel. The systems and methods also may include determining intrinsic and extrinsic characteristics related to the vehicle, the route, or the upcoming area and using this information to determine or change a braking initiation time for the vehicle system.

### CROSS-REFERENCE TO RELATED APPLICATIONS

This application claims priority to U.S. Provisional Application No. 63/335,776, filed on Apr. 28, 2022, the entire disclosure of which is incorporated herein by reference.

### BACKGROUND

### Technical Field

The present disclosure relates generally to braking systems and methods for vehicles.

### Discussion of Art

A vehicle system traveling along a route will typically need to slow down and stop at some upcoming location. For example, a vehicle may be traveling in a first section of a route which features a yellow signal, and subsequently into a second section of the route having a red signal or other location to stop, in which the vehicle is directed or required to stop. Thus, the operator of the vehicle or the onboard control system of the vehicle may need to know when to activate a braking system and/or at what level to activate the braking system, such that the vehicle slows and stops at the proper or desired location.

Some known systems have been proposed to assist the operator in slowing and stopping a vehicle prior to a stop point. These systems may utilize braking tables, which may illustrate a projected speed of the vehicle over a projected time or distance leading up to the stop location. Thus, based on the braking tables, the operator can selectively activate the braking system such that the actual speed of the vehicle tracks the projected speed, until the vehicle stops at the stop location. However, use of these conventional braking tables may have several shortcomings.

Some conventional braking systems may not consider the actual vehicle parameters in determining when/how to brake. This may impact braking performance. Additionally, some conventional braking systems may not consider the actual external parameters, such as temperature, moisture level, debris on the route, which may impact braking performance. Instead, the conventional braking tables may presume parameters of a hypothetical vehicle and environment to maintain a speed projection. The conventional braking systems may presume other factors which impact braking performance, while not accurately reflected the intrinsic and extrinsic factors at play on the route and the vehicle. Although these conventional braking systems may presume default factors to predict stopping distance, the actual vehicle and weather conditions or parameters may provide a far greater and more accurate braking performance, which may allow the vehicle to initiate braking in response to current conditions, and thus may improve overall braking performance. Since the braking curve may only be as accurate as the accuracy of the inputted parameters, these conventional braking systems may convey inaccurate information to the vehicle operator.

It may be desirable to have a system and method that differs from those that are currently available.

### BRIEF DESCRIPTION

In accordance with one example or aspect, a method is provided that may include determining a weather condition for an upcoming area through which a first vehicle system may travel. The method may include determining one or more intrinsic characteristics of the first vehicle system related to one or more interfaces between the first vehicle system and a route that may be traveled upon by the first vehicle system through the upcoming area. The one or more intrinsic characteristics may be determined based on the weather conditions. The method may further include determining one or more extrinsic characteristics of one or more of the first vehicle system, the route, or the upcoming area. The method may include determining or changing a braking initiation time for the first vehicle system to begin engaging one or more brakes of the first vehicle system in the upcoming area based on the one or more intrinsic characteristics and the one or more extrinsic characteristics.

In accordance with one example or aspect, a system is provided that may include a first vehicle system, a device, and a controller. The device may determine a weather condition for an upcoming area through which the first vehicle may travel. The controller may identify one or more intrinsic characteristics of the first vehicle system related to one or more interfaces between the first vehicle system and a route that may be traveled upon by the first vehicle system through the upcoming area. The one or more intrinsic characteristics may be determined based on the weather conditions. The controller may identify one or more extrinsic characteristics of one or more of the first vehicle system, the route, or the upcoming area. The controller may determine a braking initiation time for the first vehicle system to begin engaging one or more brakes of the first vehicle system in the upcoming area based on the one or more intrinsic characteristics and the one or more extrinsic characteristics.

In accordance with one example or aspect, a method is provided that may include determining a weather forecast for an upcoming area during a time period in which a first vehicle system may be expected to be moving through the upcoming area. The method may include determining one or more intrinsic characteristics of the first vehicle system related to one or more interfaces between the first vehicle system and a route that may be traveled upon by the first vehicle system through the upcoming area. The one or more intrinsic characteristics may be determined based on the weather forecast. The method may further include determining one or more extrinsic characteristics of one or more of the first vehicle system, the route, or the upcoming area. The method may include determining or changing a braking initiation time for the first vehicle system to begin engaging one or more brakes of the first vehicle system in the upcoming area based on the one or more intrinsic characteristics and the one or more extrinsic characteristics.

### BRIEF DESCRIPTION OF THE DRAWINGS

The subject matter may be understood from reading the following description of non-limiting embodiments, with reference to the attached drawings, wherein below:

FIG. 1 illustrates one example of a brake control system, according to one example;

FIG. 2 illustrates a flowchart of an embodiment of method of adjusting braking and prediction models based on weather conditions and external factors, according to one example; and

FIG. 3 illustrates a functional block diagram of an example neural network that can be used by a brake control system, according to one example.

### DETAILED DESCRIPTION

Embodiments of the subject matter described herein relate to braking systems and methods that take weather conditions into account to determine a braking algorithm. With respect to rail vehicles, the systems and methods can determine when automatic brakes (or train brakes, where all brakes are applied), car brakes (where the brakes of one or more individual cars are applied), consist brakes (where the brakes of the cars and locomotives within a consist are applied), independent brakes (where the brakes of locomotives are applied), parking brakes (e.g., hand brakes), automatic brakes with bail off (apply the automatic brakes of the cars but not the locomotives) are applied and to what degree each braking system is applied based on weather conditions, intrinsic characteristics of the vehicle and/or route, extrinsic characteristics of the vehicle and/or route. Optionally, the systems and methods can determine which brakes or sets of brake devices are applied based on the weather conditions, intrinsic and extrinsic characteristics, and the like. With respect to non-rail vehicles (such as automobiles, and marine vessels), the systems and methods can determine which brakes to apply, when to apply the brakes, and/or how to apply the brakes based on the weather conditions, intrinsic and extrinsic characteristics. As one example, a weather condition may be determined and used to determine operational settings for controlling braking of the vehicle system to improve the accuracy of predicted braking times and distances based on the weather condition(s).

Weather conditions may play a role in surface conditions of a route and a vehicle, for example a route and a wheel. These weather or external conditions may alter forces at play on the vehicle. The braking systems may have or use a braking algorithm to determine a brake initiation time for the vehicle. This initiation time may be calculated to ensure there is sufficient time for the vehicle to come to a complete stop or to slow to no faster than a designated speed within a designated distance. However, many braking algorithms may not make accommodations for weather conditions or various other external characteristics.

Inputs may be provided to the braking system such as temperature, humidity, dew point, and the like, which may indicate weather events such as rain, snow, or ice. These inputs may improve the safety and efficacy of the braking system. Other factors may include route conditions such as wet debris on the route (e.g., leaves on the route) or other seasonal environmental impacts. With each factor that may be input, the braking system may make a calculation adjustment in the braking algorithm for the expected friction coefficients to determine the initiation time. The calculation adjustments may be in a more conservative direction (e.g., elongating a braking curve) from a base calculation which may be determined for ideal or normal external conditions.

The impact on the braking algorithm to calculate the predicted braking curve and/or the braking initiation time may be dependent on a variety of sources such as: contact surfaces, temperature, dew point, ambient moisture level, wind, and the like. These factors may be modeled independently and then included in a cumulative calculation.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, unmanned aircraft (e.g., drones), mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In one example, the calculations of when and/or how to brake based on the weather conditions and/or other factors may be performed off-board the vehicle systems and then communicated to the vehicle systems. For example, an off-board vehicle control system such as a positive vehicle control system or a negative vehicle control system may receive sensor inputs, operator inputs, etc. that indicate the weather conditions, vehicle parameters, route parameters, etc. In one example, the calculations of when and/or how to brake based on the weather conditions may be implemented in an artificial intelligence (AI) or machine-learning system. Based on at least some of this information and/or other information, the off-board vehicle control system may determine when a particular vehicle system should begin braking and/or how the settings of the braking system of that vehicle system should change as a function of time, distance, location, etc. to ensure that the vehicle system may be able to slow to a designated speed within a designated distance and/or stop within the designated distance given the inputs. This information may be communicated to the vehicle system (e.g., the braking system and/or controller onboard the vehicle system) and then used by the braking system and/or controller in slowing and/or stopping the vehicle system. The positive vehicle control system may be a system that sends signals to vehicle systems to grant permission for the vehicle systems to enter different route segments, travel above various speeds, or the like. Absent receiving a signal, the vehicle system may automatically not enter a route segment, travel above a designated speed, etc. One example of a positive vehicle control system is a positive train control (PTC) system. The negative vehicle control system may be a system that sends signals to vehicle systems to deny permission for the vehicle systems to enter different route segments, travel above various speeds, or the like. Absent receiving a signal, the vehicle system may enter a route segment, travel above a designated speed, etc., but upon receiving a signal, the vehicle system may automatically not enter into a route segment, travel above a designated speed, etc.

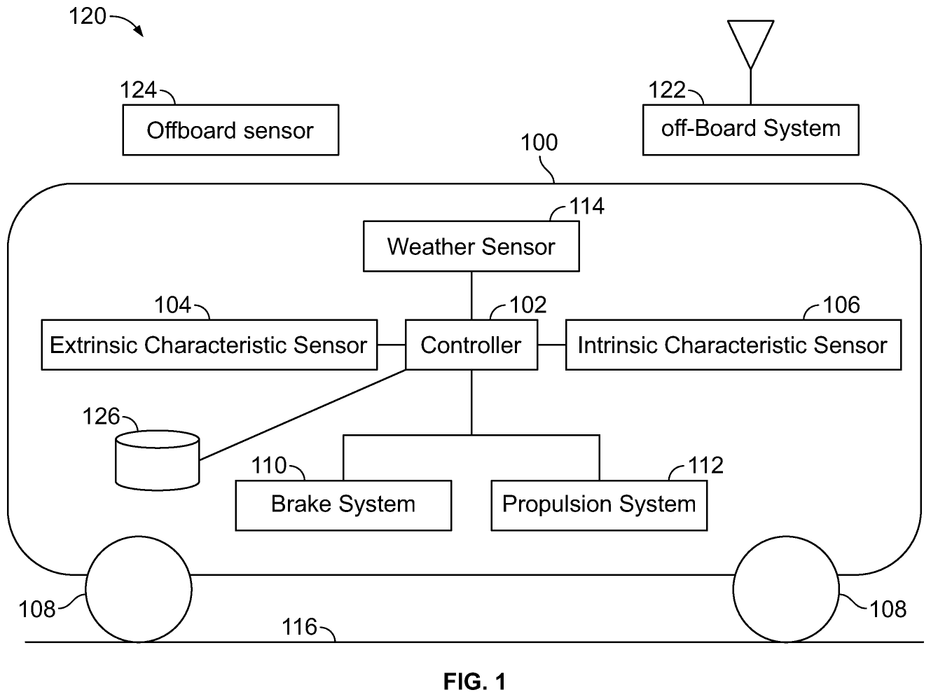

FIG. 1 illustrates one example of a brake control system 120. As shown in FIG. 1, a vehicle system 100 may travel along a route 116. The vehicle system may be propelled by a propulsion system 112 (e.g., one or more engines, motors, alternators, generators, batteries, turbines, and/or the like). As part of the travel along the route, the vehicle may need to slow down and stop at some upcoming stop point or location. Thus, the vehicle may need to begin activating a braking system 110 to initiate the braking initiation time to ensure the vehicle may be able to stop at the stop point. There may be different types of brake systems. For example, there may be two different types of airbrake systems in use, such as freight air brakes and electronically controlled pneumatic (ECP) air brakes. In the former, control and actuation of the brake system are controlled using airbrake pressure in the brake system (e.g., in conduits, cylinders, reservoirs, etc., of the brake system). In the ECP system, control of the brake system is communicated using electrical signals and actuation of the brake system is controlled using airbrake pressure. There can be limitations in applying some of these types of brake systems. For example, in airbrake systems, there can be temporal limitations in activating the brake system due to the time needed to pneumatically communicate signals and to recharge pressure in the brake system.

A friction coefficient may exist between the vehicle, specifically wheels 108 of the vehicle and the route. The friction coefficient may change based on various factors, such as weather conditions, vehicle characteristics, route characteristics, etc. For example, when the weather conditions are wet and/or icy, the friction coefficient may be reduced, thereby potentially requiring a greater distance and/or time to stop the vehicle. When the weather is dry and the temperature is above freezing, the friction coefficient may be larger, thereby potentially requiring less distance and/or time to stop the vehicle. The amount of wind, specifically a strong crosswind, may impact the friction coefficient. For example, a strong crosswind may reduce contact between the wheel and the route, this reduction in contact may result in a reduced friction coefficient. Additionally, if there is wind there may also be more debris on the route which may reduce the friction coefficient.

Currently, weather conditions and other external factors or extrinsic characteristics may not be accommodated for or may not be accurately or adequately accommodated for by a braking algorithm, a braking curve, or a braking initiation time of the braking system. Conditions such as temperature, humidity, dew point, and the like may be indicative of weather events such as rain, snow, or ice. These weather events may impact the braking system and an expected braking distance or braking time.

The vehicle system may include a weather sensor 114 that may determine the weather conditions for an area through which the vehicle system will travel and/or in which the vehicle system currently may be traveling. In one example, the vehicle system may receive the weather conditions from an offboard source, such as a dispatch, another vehicle, a weather service (e.g., National Weather Service or the like), or the like. The weather conditions may include precipitation, temperature, wind speed, dew point, barometric pressure, and the like. The weather sensor may be a device capable of receiving and communicating observational data collected by doppler radar, radiosondes, weather satellites, vehicle operators, and other instruments fed into computerized forecast models. For example, the weather sensor may be a humidity or precipitation sensor, a thermometer, a barometer, an anemometer, a wind vane or windsock, a rain gauge, a receiver or transceiver, keyboard, microphone, or like devices able to measure and/or receive information regarding weather conditions.

The weather sensor may communicate the weather conditions to a controller 102. The controller may include microcontrollers, processors, microprocessors, or other logic devices that operate based on instructions stored on a tangible and non-transitory computer readable storage medium, such as software applications stored on a memory. The controller may use this information to change how the vehicle system brakes, as described herein.

Additionally, the controller may receive information regarding extrinsic characteristics from an external characteristic sensor 104. The extrinsic characteristics may include the temperature of the wheel(s) or route, the route contour, the route wear, the amount of flexion of the route, debris on the route (which may be impacted by weather, such as wet or dry leaves, ice, etc.), or the like. The external characteristic sensor may include an onboard or offboard sensor 124 such as a thermometer, infrared (IR) temperature sensor, hot wheel detector, a camera, a sonar transducer, an operator input, a route database, or the like. The extrinsic characteristics may be independent of the weather conditions or the extrinsic characteristics may be impacted by (e.g., dependent upon) the weather conditions. Characteristics that are independent of weather may have a constant impact on braking regardless of weather conditions, such as a route curvature. That is, regardless of the weather conditions, the curvature of a given portion of the route may remain the same, and the impact of the curvature on braking may remain the same. Characteristics that are dependent on weather conditions may have a variable impact depending on weather conditions. For example, debris on the route may have a different impact on the braking system if the weather is dry and the temperature is above freezing compared to when the weather is wet, and the temperature is below freezing. Where the weather is wet and the temperature is below freezing, debris may freeze to the route and may reduce the friction coefficient between the wheels and the route.

The controller may receive information regarding intrinsic characteristics from an intrinsic characteristic sensor 106. The intrinsic characteristics may include wheel material, route material, or the like. The intrinsic characteristic sensor may be an onboard device to determine wheel material and route material during the trip, an offboard device to determine the wheel material and route material during the trip or at a station when the vehicle may be stationary. For example, the intrinsic characteristic sensor may be an input device such as a control panel, microphone, switch, keyboard, or the like that receives an operator input indicating the intrinsic characteristic(s). In one embodiment, the intrinsic characteristic sensor may be a database or memory 126 that may store information indicative of the intrinsic characteristics, such as from a trip manifest or a vehicle manifest. The material of the wheel and the surface of the route may impact the time and distance needed to brake. Generally, a kinetic friction coefficient may be known between various materials. The material of both the wheel and the surface of the route are determined in order to determine the predicted kinetic friction coefficient, and thus the predicting time and distance needed for braking. The friction coefficient required to stop between known materials may be impacted by weather conditions. For example, a typical friction coefficient required to stop a vehicle with steel wheels along a steel route surface may be 0.7. However, the same vehicle along the same route in wet conditions may have a friction coefficient of 0.4. These weather conditions may greatly impact braking time and braking distance.

One or more off-board systems 122 may communicate with the controller and the vehicle system. The off-board system may be capable of measuring, calculating, or receiving inputs regarding weather conditions, intrinsic characteristics, and/or extrinsic characteristics. Based on these inputs, the off-board system may be capable of adjusting operation of the vehicle system, specifically the braking system. The off-board system may include transceiving circuitry for wireless communication with the vehicle system. The off-board system may communicate control signals to control (directly or indirectly) the brake system. In one embodiment, the off-board system may be a PTC system.

The brake control system may include a braking algorithm that provides braking distance and instructions that are based on default or normal conditions. The braking algorithm may implement AI or machine-learning, as discussed further below. The instructions may include when to initiate the braking system, to what degree or strength the braking system is implemented, which components of the braking system to use, or the like. By implementing one or more inputs of weather conditions or other factors into braking algorithms, the predictive capabilities of the brake control system may be improved. Specifically, the braking control system may be improved when the input relates factors that may previously have been viewed independently of braking algorithms and braking tables, such as weather conditions, extrinsic characteristics, and/or intrinsic characteristics. The brake control system may use any input individually, for example only weather conditions, however the more inputs the brake control system receives, the greater the predictive capabilities of the brake control system.

The controller of the brake control system receives various inputs corresponding to factors or characteristics about weather conditions, the vehicle, and/or the route and uses this information to determine the braking initiation time that allows the vehicle to stop at a designated stop point. The controller then communicates the determined braking initiation time to the brake system to stop or slow down the vehicle. In one example, the controller may receive information from the weather sensor indicating that the weather conditions are dry, with little wind, and the temperature is above freezing at a given portion of the route. The controller may receive information from the intrinsic characteristic sensor that the wheel and the route are both made of steel. Finally, the controller may receive information from the extrinsic characteristic sensor that for the given portion of the route, the curvature of the route may be substantially straight and the contour of the route may be substantially flat. Based on the information from the weather sensor, intrinsic characteristic sensor, and extrinsic characteristic sensor, the controller may determine that the braking system should be initiated in compliance with normal or ideal conditions. That is to say, the given weather conditions, extrinsic characteristics, or internal characteristics may not substantially impact the friction coefficient or otherwise negatively impact braking performance.

In one example, the controller may receive information from the weather sensor indicating that the weather conditions for a given portion of the route include snow, strong wind, and a temperature below freezing. The controller may receive information from the intrinsic characteristic sensor that the wheel and the route are both made of steel. The controller may receive information from the extrinsic characteristic sensor that the curvature of the given portion of the route includes a substantial bend, and the contour of the surface may be substantially curved. Based on the weather conditions and the material of the wheel and the route, the controller may determine that the braking system should be initiated earlier than under ideal conditions, as the present conditions may reduce the friction coefficient and increase the time and distance needed to slow or stop at a given stop point. Additionally, based on the inputs from the extrinsic characteristic sensor, the controller may determine that the braking system should be initiated sooner because of the curve in the route and the contour of the surface. The curve in the contour of the surface may mean that there may be less surface area interaction between the wheels and the route, which may reduce the friction coefficient.

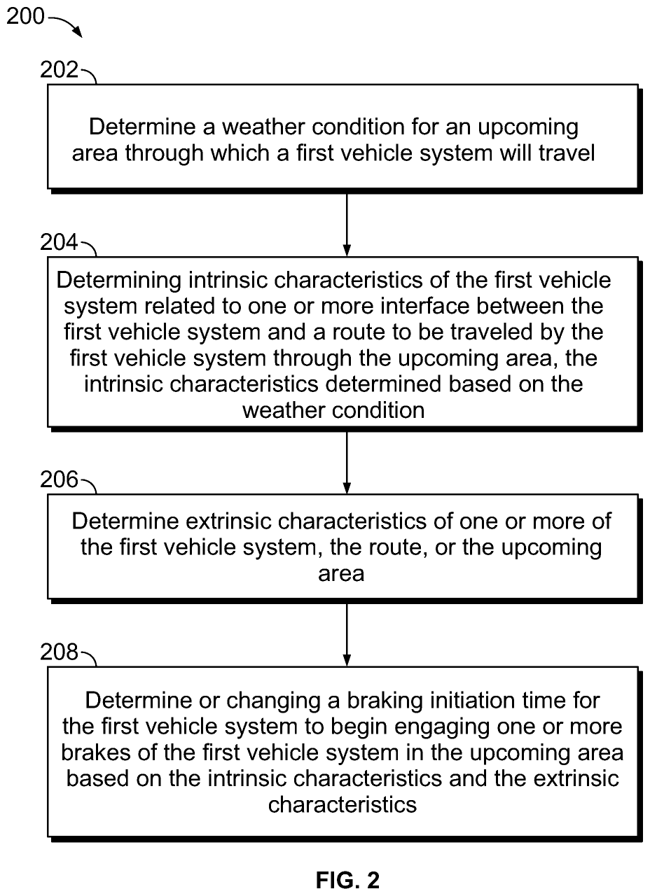

FIG. 2 illustrates a flowchart of an embodiment of method 200 of adjusting braking and prediction models based on weather conditions and external factors, according to one example. The method may represent operations performed by a controller of a vehicle system, such as the controller 102 of the brake control system shown in FIG. 1. At step 202, a weather condition for an upcoming area through which the vehicle system may travel or is traveling may be determined. The weather condition may be determined based on factors such as a forecasted weather condition for the area, the current weather of the area as determined by one or more sensors or devices onboard the vehicle, the aftereffects of a weather event in the area, or the like. The factors may include temperature, wind, debris, moisture level, or the like. These factors may be determined or obtained from an onboard device or sensor, an offboard device or sensor, a forecasting system, or the like.

The weather conditions or events may be measured for an upcoming area through which a vehicle system may be expected to travel by using a weather forecast for the upcoming area at the time at which the vehicle system may be expected to travel. The weather forecast may be determined by observational data collected by doppler radar, radiosondes, weather satellites, and other instruments fed into computerized forecast models. The weather forecast may then be communicated to a controller that uses the weather forecast as an input in determining braking initiation time for the vehicle.

The weather condition determined may be related to an after-weather event change. The after-weather event change may be related to the surface of the route, such as ice or debris on the surface of the route that may impact engagement with the vehicle or wheels of the vehicle and impact braking. The after-weather event may include debris that is on the surface of the route that may impact braking of the vehicle by reducing the friction coefficient between the wheels and the route. The debris on the surface may be the result of a prior weather event such as wind, hurricane, ice or sleet, tornado, or the like. The after-weather event may be determined by cameras or sensors onboard the vehicle or at wayside locations offboard the vehicle. After-weather events may be important for determining braking initiation time because the present forecast or weather condition may be ideal conditions with no rain or adverse weather conditions. However, the after-weather event may determine rain along the route an hour prior to travel, resulting in a route that may still wet and potentially slick. The residual effects of past weather events may impact braking of a vehicle along the route.

The weather conditions determined may be related to real-time weather events. The real-time weather conditions may be determined by sensors onboard the vehicle or at wayside locations offboard the vehicle. The weather conditions determined may relate to ambient moisture, wind, atmospheric pressure, or the like. The weather conditions may be determined by a second vehicle that may be movable along the same route as the first vehicle, where the second vehicle may be ahead of the first vehicle in a direction of movement of the first vehicle. The second vehicle may be movable near the route of the first vehicle, but not necessarily along the route. For example, the second vehicle may be ahead of the first vehicle on or near the route and may report the current weather conditions along the route to the first vehicle. In one embodiment, the second vehicle may be a flying vehicle, such as a drone. Optionally, the second vehicle may be a rail vehicle traveling along the route in front of the first vehicle. In one embodiment, the second vehicle may be an autonomous rail-based drone. Optionally, the second vehicle may be an automobile traveling in front of the first vehicle. In one embodiment, the second vehicle may be an aquatic vehicle. The second vehicle may be movable between a first position in which the second vehicle may be positioned on or near the first vehicle and a second position in which the second vehicle may be positioned in front of the first vehicle. The second position may be the position where the second vehicle gathers information about the weather conditions along the route in front of the first vehicle. In one example, the first vehicle and the second vehicle may be different types of vehicles, such that the first vehicle and the second vehicle travel on different routes. For example, the first vehicle may travel on a road while the second vehicle may travel on a track, or vice versa. The first vehicle and the second vehicle may require different licenses or licensures to operate.

At step 204, intrinsic characteristics of the vehicle system related to one or more interfaces between the vehicle system and a route to be traveled may be determined. The intrinsic characteristics may include wheel material, route material, or the like. These intrinsic characteristics may be obtained from an operator input based on the particular vehicle and the particular route, an onboard device to determine wheel material and route material during the trip, an offboard device to determine the wheel material and route material during the trip or at a station when the vehicle is stationary.

Intrinsic characteristics of the wheel of the vehicle and the surface of the route may impact the braking of the vehicle. Specifically, the material of the wheel and the surface of the route may impact the time needed to brake. Generally, a kinetic friction coefficient may be known between various materials. The material of both the wheel and the surface of the route are determined in order to determine the predicted kinetic friction coefficient. The friction coefficient required to stop between known materials may be impacted by weather conditions. For example, a typical friction coefficient required to stop a vehicle with steel wheels along a steel route surface may be 0.7. However, the same vehicle along the same route in wet conditions may have a friction coefficient of 0.4. These weather conditions may greatly impact braking time and braking distance.

At step 206, extrinsic characteristics of the vehicle system, the route, or the upcoming area are determined. The extrinsic characteristics may include the wheel or route temperature, the route contour, the route wear, the amount of flexion of the route, debris on the route (which may be impacted by weather, such as wet or dry leaves, ice, or the like). The extrinsic characteristics may be independent of the weather conditions, or the extrinsic characteristics may be impacted by (e.g., dependent upon) the weather conditions. Characteristics that are independent of weather may have a constant impact on braking regardless of weather conditions, such as a route curvature. That is, regardless of the weather, the curvature of a given portion of the route may remain the same, and the impact of the curvature on braking may remain the same. Characteristics that are dependent on weather conditions may have a variable impact depending on weather conditions. For example, debris on the route may have a different impact on the braking system if the weather is dry and the temperature is above freezing compared to when the weather is wet and the temperature is below freezing. Where the weather is wet and the temperature is below freezing, debris may freeze to the route and may reduce the friction coefficient between the wheels and the route. The wheel temperature may be the measured or estimated temperature of the material from which the wheel is formed. This temperature can be determined, received, or obtained from an onboard or offboard sensor such as a thermometer, infrared (IR) temperature sensor, hot wheel detector, etc. that monitors or measures the wheel temperature. Hotter or warmer wheels may not require as much time or distance to brake to a designated speed or within a designated distance due to the coefficient of friction between the wheel and a route potentially being increased for warmer wheels and/or routes. Conversely, colder or cooler wheels may require more time or distance to brake to the designated speed or within the designated distance due to the coefficient of friction between the wheel and a route potentially being decreased for cooler wheels and/or.

Extrinsic characteristics of the vehicle, the route, and/or the upcoming area may impact the braking of the vehicle. One extrinsic characteristic that may be determined is the curvature of the surface of the route. Newer or less travelled routes may have a greater radius of curvature of the surface of the route, while more travelled routes may have a flatter surface. The greater curvature may result in less contact between the wheel and the route. The less contact means that less braking force may be implemented by the braking system on the route for a given brake setting. Thus, more time may be needed for the braking system to stop the vehicle. Braking initiation time may need to begin earlier as a radius of curvature of the surface of the route increases. Another extrinsic characteristic that may be determined is debris on the route surface. Debris may be based on weather events, such as leaves on the route. The characteristics of the debris may additionally be evaluated. For example, wet leaves and dry leaves may have different impact of the friction coefficient required to stop the vehicle. Debris on the route may be natural build up along the route resulting from use, such as oxide build up. Oxide build up on the route may create a slicker surface, and thus reduce the friction coefficient between the wheels and the route.

The route contour, the amount of flexion of the route, the route wear, and the debris on the route may all be measured or estimated using a device, such as a UV sensor, a sonar transducer, a camera, or a high-speed camera onboard the vehicle or at a wayside location offboard the vehicle. Optionally, the route contours, flexion of the route, route wear or damage, route debris, etc. may be determined from a route database or other memory structure 126, may be input by an operator, may be received from an off-board control system, etc.

At step 208, a braking initiation time for the vehicle system to begin engaging one or more brakes of the vehicle system in the upcoming area may be determined or changed based on the intrinsic characteristics and the extrinsic characteristics. The braking initiation time may be reduced in a situation where weather conditions, such as ice, reduce the traction between the wheel and the route and reduce the friction coefficient, and thus increase the time required to stop the vehicle. Said another way, the brakes of the vehicle may need to be engaged earlier in inclement weather in order to stop the vehicle at a desired stop point.

Braking systems may include braking tables or braking curves, which may illustrate a projected speed of the train over a projected time or distance leading up to a stop point. By implementing more inputs into braking algorithms, braking tables, and/or braking curves, the predictive capabilities of the braking system may be more improved. Specifically, when the inputs relate to weather conditions that may once have been viewed independently of braking algorithms and braking tables.

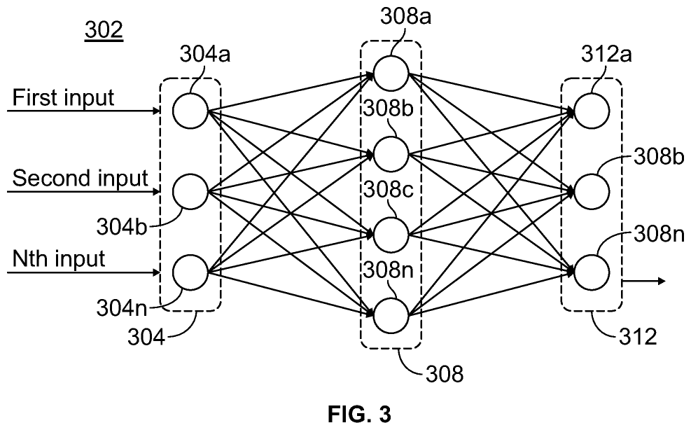

As previously stated, one or more of the braking systems described herein may be implemented in an AI or machine-learning system. FIG. 3 illustrates a functional block diagram of an example neural network 302 that can be used by a brake control system, according to one example. The brake control system may review various inputs, described above, for example a weather condition, intrinsic characteristics of the vehicle system and the route, extrinsic characteristics of the vehicle system and the route, or the like. In an example, the neural network can represent a long short-term memory (LSTM) neural network. In an example, the neural network can represent one or more recurrent neural networks (RNN). The neural network may be used to implement the machine learning as described herein, and various implementations may use other types of machine learning networks. The neural network may include an input layer 304, one or more intermediate or hidden layers 308, and an output layer 312. Each layer 304, 308, 312 may include artificial individual units, or neurons. Each neuron can receive information (e.g., as input into the neural network or as received as output from another neuron in another layer or the same layer), process this information to generate output, and provide the output to another neuron or as output of the neural network. The input layer may include several input neurons 304a, 304b . . . 304n. The hidden layer may include several intermediate neurons 308a, 308b . . . 308n. The output layer may include several output neurons outputs 312a, 312b . . . 312n. The inputs may include, for example, weather conditions, intrinsic characteristics of the vehicle system and/or route, extrinsic characteristics of the vehicle system and/or route, or the like.

Each neuron can receive an input from another neuron and output a value to the corresponding output to another neuron (e.g., in the output layer or another layer). For example, the intermediate neuron 308a can receive an input from the input neuron 304a and output a value to the output neuron 312a. Each neuron may receive an output of a previous neuron as an input. For example, the intermediate neuron 308b may receive input from the input neuron 304b and the output neuron 312a. The outputs of the neurons may be fed forward to another neuron in the same or different intermediate layer.

The processing performed by the neurons may vary based on the neuron but can include the application of the various rules or criteria described herein to partially or entirely decide one or more aspects of the brake control system, for example when to engage one or more of the brakes of the vehicle system, when to change the braking initiation time for the vehicle system, or the like. The output of the application of the rule or criteria can be passed to another neuron as input to that neuron. One or more neurons in the intermediate and/or output layers can determine matches between one or more aspects of the brake control system, for example that the weather conditions may require a determined braking initiation time. As used herein, a “match” may refer to a preferred operation of the brake control system based on the inputs, for example a preferred brake initiation time. The preferred operation may be based on increasing performance, efficiency, safety, longevity, or a combination of any or all of these factors. The last output neuron in the output layer may output a match or no-match decision. For example, the output from the neural network may be that the braking initiation time may need to be reduced for a given weather condition, intrinsic characteristic, and/or extrinsic characteristic. Although the input layer, the intermediate layer(s), and the output layer may be depicted as each including three artificial neurons, one or more of these layers may contain more or fewer artificial neurons. The neurons can include or apply one or more adjustable parameters, weights, rules, criteria, or the like, as described herein, to perform the processing by that neuron.

In various implementations, the layers of the neural network may include the same number of artificial neurons as each of the other layers of the neural network. For example, the weather conditions, the intrinsic characteristics, the extrinsic characteristics, or the like may be processed to provide information to the input neurons. The output of the neural network may represent a match or no-match of the inputs to a given output. More specifically, the inputs can include historical brake control system data. The historical brake control system data can be provided to the neurons for analysis and matches between the historical brake control system data. The neurons, upon finding matches, may provide the potential matches as outputs to the output layer, which can determine a match, no match, or a probability of a match.

In some embodiments, the neural network may be a convolutional neural network. The convolutional neural network can include an input layer, one or more hidden or intermediate layers, and an output layer. In a convolutional neural network, however, the output layer may include one fewer output neuron than the number of neurons in the intermediate layer(s), and each neuron may be connected to each output neuron. Additionally, each input neuron in the input layer may be connected to each neuron in the hidden or intermediate layer(s).

Such a neural network-based brake control system can be trained by operators, automatically self-trained by the brake control system itself, or can be trained both by operators and by the brake control system itself to improve how the system operates.

The AI or machine-learning processes may be used to generate or update the machine-learning models used by the artificial neurons to compare information from the inputs with the braking control database. A machine-learning model can be or include a mathematical representation of a relationship between inputs and outputs (e.g., indications of a match between an input and a braking initiation time needed or indications of no match between input and braking initiation time needed), as generated using the machine-learning processes described herein. An input may be provided to one or more of the input neurons of the neural network after the model is created. The output neurons within the network may generate an output based on the relationships that are derived or learned by the neurons in the intermediate or hidden layer(s). Matches between the nodes within each layer and/or between the layers and/or the neurons may be created via the process of training the brake control system.

In contrast to some known artificial intelligence or machine learning systems that use supervised learning to train the systems or networks, one or more embodiments of the neural network of brake control system described herein may use unsupervised learning to train the systems. For example, actual weather conditions, intrinsic characteristics, and/or extrinsic characteristics may be used as the production data that may be input into the input neurons of the neural network for analysis and identification of matches by the neurons in the intermediate layer(s). This input information may not be known to match (or not match) to a braking initiation time prior to inputting the input information into the brake control system. Instead, the output from the neurons in the output layer of the brake control system can be examined to determine whether the system-matched input information may be correct matches of input and braking initiation time, incorrect matches of input and braking initiation time, or missed matches of inputs and braking initiation time.

The brake control system may change one or more parts of the matching rules or criteria used by the neurons in the intermediate layer(s) to examine the information, as described above. Weights or other parameters of the matching rules or criteria used by these neurons may be modified to train the brake control system to not over-match or under-match the inputs and braking outputs going forward.

In one embodiment, a method is provided that may include determining a weather condition for an upcoming area through which a first vehicle system may travel. The method may include determining one or more intrinsic characteristics of the first vehicle system related to one or more interfaces between the first vehicle system and a route that may be traveled upon by the first vehicle system through the upcoming area. The one or more intrinsic characteristics may be determined based on the weather conditions. The method further may include determining one or more extrinsic characteristics of one or more of the first vehicle system, the route, or the upcoming area. The method may includes determining or changing a braking initiation time for the first vehicle system to begin engaging one or more brakes of the first vehicle system in the upcoming area based on the one or more intrinsic characteristics and the one or more extrinsic characteristics.

In one example, the weather condition that may be determined may be a weather forecast for the upcoming area during a time period in which the first vehicle system may be expected to be moving within the upcoming area. The weather condition that may be determined may be an after weather event change to one or more of a surface of the route or debris on the surface of the route in the upcoming area following a weather event.

The one or more intrinsic characteristics that may be determined may include a wheel material of the first vehicle system or a route material on a surface of the route. The one or more extrinsic characteristics may include a contour of the route in the upcoming area. The one or more extrinsic characteristics may include one or more of a temperature of a wheel of the first vehicle system, a temperature of the route in the upcoming area, and a wind condition in the upcoming area.

The braking initiation time may change responsive to different radii of curvature of the contour of the route that will be travelled. The braking initiation time for the first vehicle system may be determined by comparing a baseline friction coefficient between the first vehicle system and the route to a predicted friction coefficient based on one or more of the weather conditions, the one or more intrinsic characteristics, and the one or more extrinsic characteristics.

The weather condition for the upcoming area may be determined by a second vehicle system that may be movable between a first position in which the second vehicle system may be positioned on the first vehicle system and a second position in which the second vehicle system may be positioned in front of the first vehicle system in the upcoming area. The second vehicle system may be one of: a land-based vehicle, an aquatic vehicle, or a flying vehicle. The weather condition may be a change in atmospheric pressure.

In one embodiment, a system is provided that may include a first vehicle system, a device, and a controller. The device may determine a weather condition for an upcoming area through which the first vehicle may travel. The controller may identify one or more intrinsic characteristics of the first vehicle system related to one or more interfaces between the first vehicle system and a route that may be traveled upon by the first vehicle system through the upcoming area. The one or more intrinsic characteristics may be determined based on the weather conditions. The controller may identify one or more extrinsic characteristics of one or more of the first vehicle system, the route, or the upcoming area. The controller may determine a braking initiation time for the first vehicle system to begin engaging one or more brakes of the first vehicle system in the upcoming area based on the one or more intrinsic characteristics and the one or more extrinsic characteristics.

In one example, the device for determining the weather condition for the upcoming area may be a second vehicle system that may be movable between a first position in which the second vehicle system may be positioned on the first vehicle system and a second position in which the second vehicle system may be positioned in the upcoming area, in front of the first vehicle system. The second vehicle system may be one of: a land-based vehicle, an aquatic vehicle, or a flying vehicle.

The controller may determine the braking initiation time for the first vehicle system by comparing a baseline friction coefficient between the first vehicle system and the route to a predicted friction coefficient based on one or more of the weather conditions, the one or more intrinsic characteristics, and the one or more extrinsic characteristics.

In one embodiment, a method is provided that may include determining a weather forecast for an upcoming area during a time period in which a first vehicle system may be expected to be moving through the upcoming area. The method may include determining one or more intrinsic characteristics of the first vehicle system related to one or more interfaces between the first vehicle system and a route that may be traveled upon by the first vehicle system through the upcoming area. The one or more intrinsic characteristics may be determined based on the weather forecast. The method may further include determining one or more extrinsic characteristics of one or more of the first vehicle system, the route, or the upcoming area. The method may include determining or changing a braking initiation time for the first vehicle system to begin engaging one or more brakes of the first vehicle system in the upcoming area based on the one or more intrinsic characteristics and the one or more extrinsic characteristics.

In one example, the one or more intrinsic characteristics that may be determined may include a wheel material of the first vehicle system or a route material on a surface of the route. The one or more extrinsic characteristics may include a contour of the route in the upcoming area. The one or more extrinsic characteristics may include one or more of a temperature of a wheel of the first vehicle system, a temperature of the route in the upcoming area, and a wind condition in the upcoming area.

The braking initiation time may begin earlier as a radius of curvature of the contour of the route may decrease. The braking initiation time for the first vehicle system may be determined by comparing a baseline friction coefficient between the first vehicle system and the route to a predicted friction coefficient based on one or more of the weather forecast, the one or more intrinsic characteristics, and the one or more extrinsic characteristics.

In one embodiment, the brake control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the brake control system may include a policy engine that may apply one or more policies. These policies may be based at least in part on characteristics of a given item of equipment or environment. With respect to control policies, a neural network can receive input of a number of environmental and task-related parameters. These parameters may include an identification of a weather condition, an intrinsic characteristic of the vehicle system and/or route, an extrinsic characteristic of the vehicle system and/or route, data from various sensors, and the like. The neural network can be trained to generate an output based on these inputs, with the output representing an action or sequence of actions that the brake control system should take to accomplish the braking objective. During operation of one embodiment, a determination can occur by processing the inputs through the parameters of the neural network to generate a value at the output node designating that action as the desired action. This action may translate into a signal that causes the brake control system to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network may have a set of parameters representing weights of its node connections. A number of copies of this network may be generated and then different adjustments to the parameters are made, and simulations are done. Once the output from the various models are obtained, they may be evaluated on their performance using a determined success metric. The best model is selected, and the controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., weather conditions, intrinsic characteristics, extrinsic characteristics), use a model that associates inputs with different brake control system operating modes to select an operating mode of the one or more brake control systems of the vehicle system, and then provide an output (e.g., the operating mode selected using the model). The controller may receive additional input of the change in operating mode that was selected, such as analysis of noise or interference in communication signals (or a lack thereof), operator input, or the like, that indicates whether the machine-selected operating mode provided a desirable outcome or not. Based on this additional input, the controller can change the model, such as by changing which operating mode would be selected when a similar or identical input or inputs is received the next time or iteration. The controller can then use the changed or updated model again to select an operating mode, receive feedback on the selected operating mode, change or update the model again, etc., in additional iterations to repeatedly improve or change the model using artificial intelligence or machine learning.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

A reference herein to a patent document or any other matter identified as prior art, is not to be taken as an admission that the document or other matter was known or that the information it contains was part of the common general knowledge as at the priority date of any of the claims. cm What is claimed is:

1. A method comprising:
determining a weather condition for an upcoming area through which a first vehicle system will travel;
determining one or more intrinsic characteristics of the first vehicle system related to one or more interfaces between the first vehicle system and a route that will be traveled upon by the first vehicle system through the upcoming area;
determining one or more extrinsic characteristics of one or more of the first vehicle system, the route, or the upcoming area; and
determining or changing a braking initiation time for the first vehicle system to begin engaging one or more brakes of the first vehicle system in the upcoming area based on the one or more intrinsic characteristics and the one or more extrinsic characteristics.

2. The method of claim 1, wherein the weather condition that is determined is a weather forecast for the upcoming area during a time period in which the first vehicle system is expected to be moving within the upcoming area.

3. The method of claim 1, wherein the weather condition that is determined is an after weather event change to one or more of a surface of the route or debris on the surface of the route in the upcoming area following a weather event.

4. The method of claim 1, wherein the one or more intrinsic characteristics that are determined include a wheel material of the first vehicle system or a route material on a surface of the route.

5. The method of claim 1, wherein the one or more extrinsic characteristics include a contour of the route in the upcoming area.

6. The method of claim 5, wherein the braking initiation time changes responsive to different radii of curvature of the contour of the route that will be travelled.

7. The method of claim 1, wherein the one or more extrinsic characteristics include one or more of a temperature of a wheel of the first vehicle system, a temperature of the route in the upcoming area, and a wind condition in the upcoming area.

8. The method of claim 1, wherein the braking initiation time for the first vehicle system is determined by comparing a baseline friction coefficient between the first vehicle system and the route to a predicted friction coefficient based on one or more of the weather condition, the one or more intrinsic characteristics, and the one or more extrinsic characteristics.

9. The method of claim 1, wherein the weather condition for the upcoming area is determined by a second vehicle system that is movable between a first position in which the second vehicle system is positioned on the first vehicle system and a second position in which the second vehicle system is positioned in front of the first vehicle system in the upcoming area.

10. The method of claim 9, wherein the second vehicle system is one of: a land-based vehicle, an aquatic vehicle, or a flying vehicle, and
the weather condition is a change in atmospheric pressure.

11. A system comprising:
a device for determining a weather condition for an upcoming area through which a first vehicle system will travel;
a controller configured to identify one or more intrinsic characteristics of the first vehicle system related to one or more interfaces between the first vehicle system and a route that will be traveled upon by the first vehicle system through the upcoming area, the one or more intrinsic characteristics determined based on the weather condition;
the controller configured to identify one or more extrinsic characteristics of one or more of the first vehicle system, the route, or the upcoming area; and
the controller configured to determine a braking initiation time for the first vehicle system to begin engaging one or more brakes of the first vehicle system in the upcoming area based on the one or more intrinsic characteristics and the one or more extrinsic characteristics.

12. The system of claim 11, wherein the device for determining the weather condition for the upcoming area is a second vehicle system that is movable between a first position in which the second vehicle system is positioned on the first vehicle system and a second position in which the second vehicle system is positioned in the upcoming area, in front of the first vehicle system.

13. The system of claim 12, wherein the second vehicle system is one of: a land-based vehicle, an aquatic vehicle, or a flying vehicle.

14. The system of claim 11, wherein the controller is configured to determine the braking initiation time for the first vehicle system by comparing a baseline friction coefficient between the first vehicle system and the route to a predicted friction coefficient based on one or more of the weather conditions, the one or more intrinsic characteristics, and the one or more extrinsic characteristics.

15. A method comprising:
determining a weather forecast for an upcoming area during a time period in which a first vehicle system is expected to be moving through the upcoming area;
determining one or more intrinsic characteristics of the first vehicle system related to one or more interfaces between the first vehicle system and a route that will be traveled upon by the first vehicle system through the upcoming area, the one or more intrinsic characteristics determined based on the weather forecast;
determining one or more extrinsic characteristics of one or more of the first vehicle system, the route, or the upcoming area; and
determining or changing a braking initiation time for the first vehicle system to begin engaging one or more brakes of the first vehicle system in the upcoming area based on the one or more intrinsic characteristics and the one or more extrinsic characteristics.

16. The method of claim 15, wherein the one or more intrinsic characteristics that are determined include a wheel material of the first vehicle system or a route material on a surface of the route.

17. The method of claim 15, wherein the one or more extrinsic characteristics include a contour of the route in the upcoming area.

18. The method of claim 17, wherein the braking initiation time changes responsive to different radii of curvature of the contour of the route that will be travelled.

19. The method of claim 15, wherein the one or more extrinsic characteristics include one or more of a temperature of a wheel of the first vehicle system, a temperature of the route in the upcoming area, and a wind condition in the upcoming area.

20. The method of claim 15, wherein the braking initiation time for the first vehicle system is determined by comparing a baseline friction coefficient between the first vehicle system and the route to a predicted friction coefficient based on one or more of the weather forecast, the one or more intrinsic characteristics, and the one or more extrinsic characteristics.
